(19) United States
(12) Patent Application Publication
(10) Pub. No.: US 2009/0028346 A1
(43) Pub. Date: Jan. 29, 2009

(54) FM stereo transmitter and a digitized frequency modulation stereo multiplexing circuit thereof

(76) Inventors: Tain-Rein Chen, Hsinchu (TW); Wan-Jung Lin, Hsinchu (TW); Shih-Bin Wen, Hsinchu (TW); Chien-Shan Chiang, Hsinchu (TW)

Correspondence Address: Frenkel & Associates, P. C., Suite 330, 3975 University Drive, Fairfax, VA, 22030, US

(21) Appl. No.: 12/009,961

(22) Filed: Jan. 23, 2008

(30) Foreign Application Priority Data
Jul. 23, 2007 (TW) 096126755

(51) Int. Cl. H04H 20/48

(52) U.S. Cl. 381/3

(57) ABSTRACT

A digitized FM (frequency modulation) stereo multiplexing circuit for an FM stereo transmitter has a digital audio I/O interface, a digitized FM stereo multiplexing circuit, a low-pass filter and an FM circuit. When a digital audio data is inputted, a digital audio decoder decodes the digital audio data to acquire left and right channel audio signals. The left and right channel audio signals are inputted to an over-sampling unit circuits to process sampling and then to output to an FM stereo multiplexer. The FM stereo multiplexer then generates a master signal and a secondary signal by processing the sampled left and right channel audio signals. In the meanwhile a switch signal and a pilot signal are acquired with an address counter to output from a memory unit. Then the master signal, the secondary signal and the pilot signal are combined as the digital FM stereo data.

### BACKGROUND OF THE INVENTION

1. Field of the Invention

The invention relates to an frequency modulation (hereinafter FM) stereo transmitter, and more particularly to a digitized FM stereo transmitter that uses a digital multiplexer to enable the FM stereo transmitter to directly receive digital audio signals and process the digital audio signals to send out.

2. Description of the Related Art

In early days it has been proposed that two FM wireless transmitters can be used to respectively transmit left channel and right channel audio signals. Then a stereo effect can be achieved by using two wireless receivers to respectively receive the audio signals and then play the audio signals simultaneously. Nevertheless, this technique is not economic and practical.

A conventional a method of generating FM stereo signal for a conventional FM stereo transmitter that common used is as follows. Firstly, analogy audio signals of the left channel and the right channel that are usually coupled to an AUX analogy audio terminal are transformed by an analogy time division multiplexing, and then to be combined with a pilot signal as a stereo composition signal. Eventually the stereo composition signal is modulated with a carrier by an FM modulation circuit, so the FM stereo signal is sent out with an antenna.

With reference to FIG. 6, a conventional FM stereo transmitter has a right channel audio processing unit 50, a left channel audio processing unit 60, a stereo modulation unit 70, a frequency modulation unit 90 and a phase-locked-loop (PLL) frequency synchronization unit 80.

The right channel audio processing unit 50 is coupled to a right audio input R of an analogy audio terminal block 100. The right channel audio processing unit 50 has a first volume adjuster 51, a first pre-emphasis circuit 52, a first stopper 53 and a first low-pass filter 54. Firstly, a right channel audio signal goes through the first volume adjuster 51 to adjust amplitude of vibration. Then the first pre-emphasis circuit 52 lifts a high frequency signal level to receive a de-emphasis signal, so as to enhance a signal-to-noise ratio (S/N). Subsequently the right channel audio signal is further processed by the first stopper 53 and the first low-pass filter 54 to be outputted.

The left channel audio processing unit 60 is coupled to a left audio input L of an analogy audio terminal block 100. The left channel audio processing unit has a second volume adjuster 61, a second pre-emphasis circuit 62, a second stopper 63 and a second low-pass filter 64. An operation of the left channel audio processing unit 60 is the same as the right channel audio processing unit 50 as described above.

The stereo modulation unit 70 is coupled to the right channel audio processing unit 50 and the left channel audio processing unit 60. The stereo modulation unit 70 has an analog multiplexer 71, a synthesizer 73, a mute circuit 74, a switch-signal 38 KHz and a pilot signal 19 KHz. The analog multiplexer 71 is coupled to an output terminal and a switch-signal of the right channel audio processing unit 50 and the left channel audio processing unit 60. In accordance with a frequency of the switch-signal, the analog multiplexer 71 takes turn to output right channel audio signals and left channel audio signals to the synthesizer 73. The synthesizer 73 is coupled to the pilot signal 19 KHz to synthesize stereo composition signals. The stereo composition signals are then outputted via the mute circuit 74.

An input terminal of the frequency modulation unit 90 is coupled to an output terminal of the stereo modulation unit 70, and an output terminal of the frequency modulation unit 90 is coupled to an radio frequency (hereinafter RF) antenna. In this way, the stereo composition signals are loaded to an RF carrier and then to be sent out by the RF antenna.

The frequency modulation unit 90 includes a first variable capacitor VC1 and a second variable capacitor VC2, an inductance L, a first resistor r1 and a second resistor r2, an oscillator circuit 91 and a first RF amplifier 102 and a second RF amplifier 103. The first variable capacitor VC1 and the second variable capacitor VC2 are coupled to the output terminal of the stereo modulation unit 70 to adjust a capacitance value by a voltage swing of the stereo composition signals. The first RF amplifier 102 and the second RF amplifier 103 are used to be coupled to the RF antenna.

The phase-locked-loop (PLL) frequency synchronization unit 80 has a frequency generator circuit 80-1 and a phase comparator circuit 80-2. The frequency generator circuit 80-1 includes a quartz crystal oscillator circuit 81 and multiple frequency dividers 82 to 85. A base band signal Xosc 7.6 MHz generated by the quartz crystal oscillator circuit 81 is divided by the frequency dividers 82 to 85, so as to generate the switch-signal 38 KHz and the pilot signal KHz for the stereo modulation unit 70 and other base band signals.

Furthermore, the phase comparator circuit 80-2 includes a phase comparator 87, a counter 86 and a third low-pass filter 88. Two input terminals of the phase comparator 87 are respectively coupled to the frequency divider 85 of the frequency generator circuit 80-1 and an output terminal of the counter 86. An output terminal of the phase comparator 87 is coupled to the first variable capacitor VC1 and the second variable capacitor VC2 of the frequency modulation unit 90 via the third low-pass filter 88. After a setting circuit 101 sets a divided frequency value to the counter 86, a broadcast transmission signal is provided to the phase comparator 87; so as to make the phase comparator 87 compares the broadcast transmission signal with the base band signal. A comparison result signal is then outputted to the first variable capacitor VC1 and the second variable capacitor VC2 via the third low-pass filter 88. In this way, the capacitance values of the variable capacitors can be adjusted, so as to set the carrier frequency of the frequency channel.

It is clear from the above description of the conventional FM stereo transmitter is mainly used to process analogy audio signals and also uses a great quantity of analogy circuits. Therefore, a cost of integrated circuits of the conventional FM stereo transmitter can not be effectively reduced and also a noise and interference can not be effectively eliminated.

### SUMMARY OF THE INVENTION

An objective of the present invention is to provide a digitized FM stereo transmitter that uses a digital multiplexer to enable the FM stereo transmitter to directly receive digital audio signals and process the digital audio signals. The present invention is superior to the conventional analogy circuit to achieve a good anti-noise objective.

In order to achieve the above objective, the digitized FM stereo multiplexing circuit for the FM stereo transmitter in accordance with the present invention has a digital audio I/O interface, a digitized FM stereo multiplexing circuit, a low-pass filter and an FM circuit.

When a digital audio data is inputted, a digital audio decoder decodes the digital audio data to acquire left and right channel audio signals. The left and right channel audio signals are respectively inputted to the corresponding over-sampling unit circuit to process sampling and then to output to an FM stereo multiplexer. The FM stereo multiplexer then generates a master signal and a secondary signal by processing the sampled left and right channel audio signals. In the meanwhile a switch signal and a pilot signal are acquired with an address counter to output from a memory unit. Then the master signal, the secondary signal and the pilot signal are combined as the digital FM stereo data.

Then the digital FM stereo data is synchronized to be matching and the noise is adjusted to make the digital FM stereo data outputted to a low-pass filter with a serial of one bit data stream. Since the noise of the digital FM stereo data is adjusted to a high frequency area, the noise is filtered by going through the low-pass filter. Hence the high quality FM stereo signal can be restored.

### BRIEF DESCRIPTION OF THE DRAWINGS

FIG. 1 is a block diagram of an FM stereo transmitter in accordance with the present invention;

FIG. 2 is a block diagram of a digitized FM stereo multiplexing circuit in accordance with the present invention;

FIG. 3 is a detailed block diagram of an FM stereo multiplexer in accordance with the present invention;

FIG. 4 is a detailed block diagram of a re-sampling circuit in accordance the present invention;

FIG. 5 is a block diagram of an FM circuit in accordance with the present invention; and

FIG. 6 is a block diagram of a conventional FM stereo transmitter in accordance with prior art.

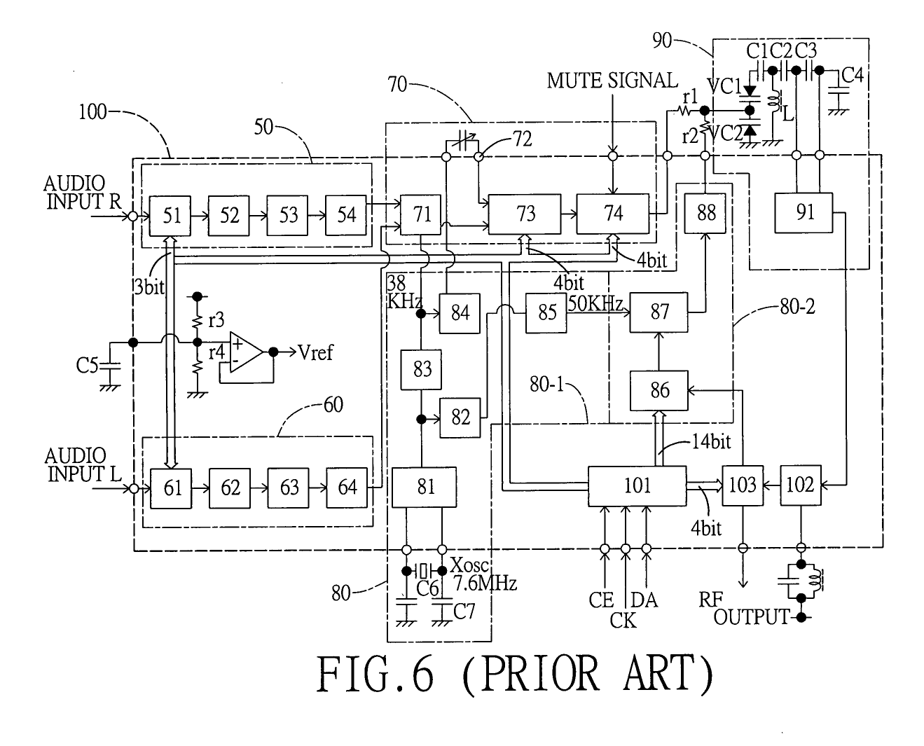

### DETAILED DESCRIPTION OF THE INVENTION

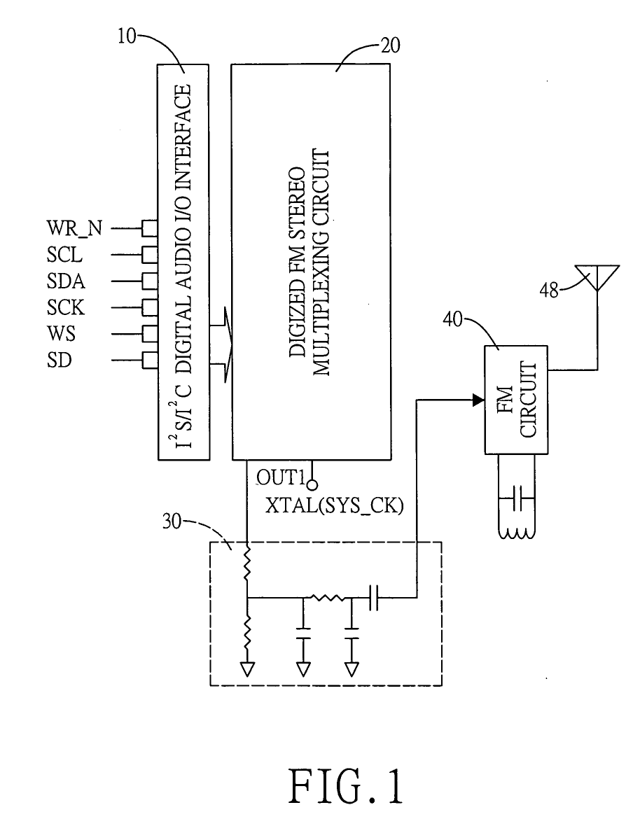

With reference to FIG. 1, a preferred embodiment of an FM stereo transmitter in accordance with the present invention has a digital audio I/O interface 10, a digitized FM stereo multiplexing circuit 20, a low-pass filter 30 and an FM circuit 40.

The digital audio I/O interface 10 is used for coupling with a compatible digital audio storage device to acquire digital audio data. The digital audio I/O interface 10 is of IIS or IIC digital audio format interface, such as CD-ROM or MP3 digital output interface and the like.

The digitized FM stereo multiplexing circuit 20 acquires parallel digital audio data via the digital audio I/O interface 10 to process digitized multiplexing modulation. Then a stereo composition signal of serial digital data format is outputted via one single output OUT1 shown in a below location of the block diagram of the digitized FM stereo multiplexing circuit 20.

The low-pass filter 30 is coupled to the output OUT1 of the digitized FM stereo multiplexing circuit 20 to transform the stereo composition signal of serial digital data format into an analogy stereo composition signal to output the analogy stereo composition signal.

The FM circuit 40 has an input terminal coupled to an output terminal of the low-pass filter 30 and an output terminal coupled to a radio frequency (hereinafter RF) antenna 50. The FM circuit 40 is used to load the analogy stereo composition signal to a radio frequency carrier, and then the RF antenna 50 radiates out the analogy stereo composition signal.

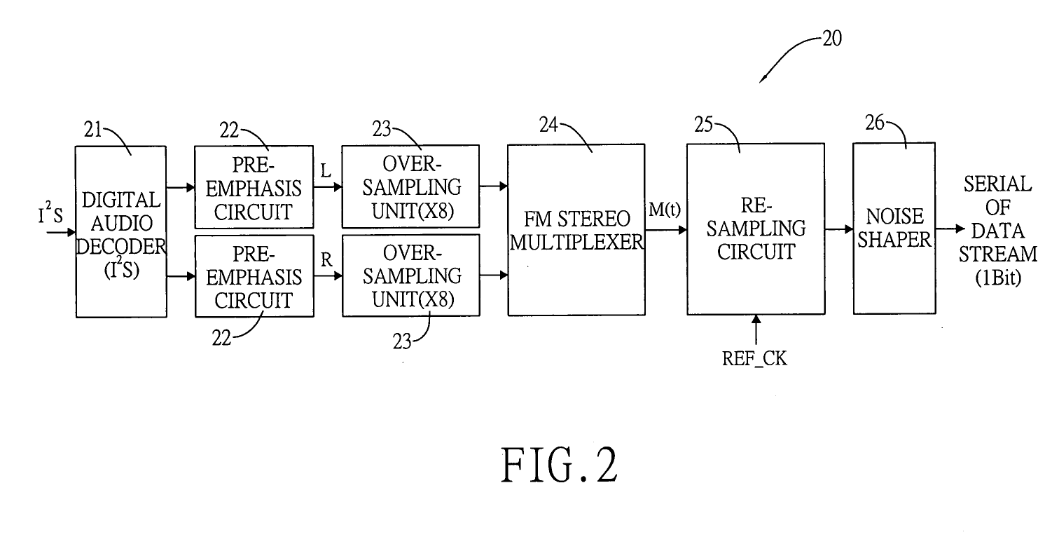

With reference to FIG. 2, a block diagram of the digitized FM stereo multiplexing circuit 20 in accordance with the present invention has a digital audio decoder 21, two pre-emphasis circuits 22, two over-sampling units 23, an FM stereo multiplexer 24, a re-sampling circuit 25 and a noise shaper 26.

The digital audio decoder 21 is coupled to the digital audio I/O interface 10 to acquire the parallel digital audio data to decode the parallel digital audio data and respectively output a left channel audio signal and a right channel audio signal (L/R).

The two pre-emphasis circuits 22 are respectively coupled to output terminals of the digital audio decoder 21. The two pre-emphasis circuits 22 enhance a signal-to-noise ratio (S/N) of a high frequency area of the corresponding left channel audio signal and right channel audio signal (L/R), so as to avoid noise interference of high frequency environment.

The two over-sampling unit circuits 23 are respectively coupled to the corresponding pre-emphasis circuit 22 to process high-rate sampling on the left channel audio signal and the right channel audio signal (L/R) to output. In this preferred embodiment, the over-sampling unit circuits 23 are of eight-times sampling rate.

The FM stereo multiplexer 24 are coupled to output terminals of the two over-sampling unit circuits 23 to combine the sampled left channel audio signal and the right channel audio signal (L/R) with a pilot signal, so as to output a digital FM stereo data M(t).

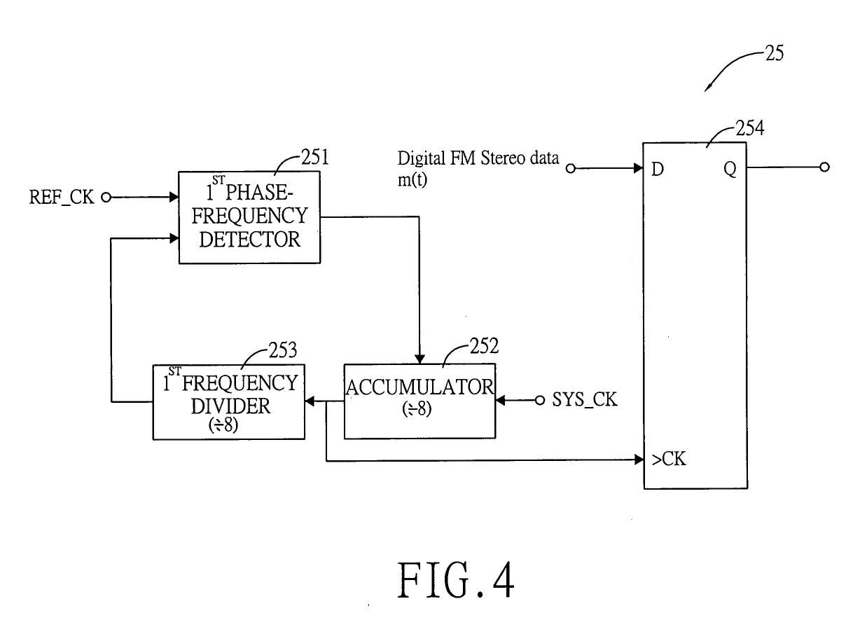

With reference to FIG. 4, the re-sampling circuit 25 includes a first phase-frequency detector 251, an accumulator 252, a first frequency divider 253 that is to be divided by N and a D-Type Flip-Flop 254. The first phase-frequency detector 251 is coupled to a reference clock signal REF_CK to check with a system clock signal SYS_CK. The system clock signal SYS_CK chooses one frequency signal from 8-40 MHz. The system clock signal SYS_CK is inputted to the accumulator 252 and then further processed by the first frequency divider Then the system clock signal SYS_CK and the reference clock signal REF_CK are simultaneously inputted to the first phase-frequency detector 251. At this moment, the first phase-frequency detector 251 detects a phase contrast of the two clock signals and then inputs to the accumulator 252. Eventually a reference signal divided by N, wherein N equals to eight in this preferred embodiment, is outputted to a clock terminal CK of the D-Type Flip-Flop 254. At this moment, an input terminal of the D-Type Flip-Flop 254 is coupled to an output terminal of the FM stereo multiplexer 24. Hence the digital FM stereo data M(t) can be synchronized to be matching with the reference signal via the D-Type Flip-Flop 254. That is to say, no matter how the clock signal frequency changes, the digital FM stereo data M(t) and the reference signal can be matching. Therefore the present invention is adaptable for different system clocks.

The noise shaper 26 is coupled to an output terminal of the re-sampling circuit 25 to acquire the digital FM stereo data M(t), so as to lift a noise of a digital stereo audio signal to the high frequency area. Then the digital stereo audio signal is outputted to the low-pass filter 30, so as to filter the noise of the high frequency area. The noise shaper 26 is a Sigma-delta modulator.

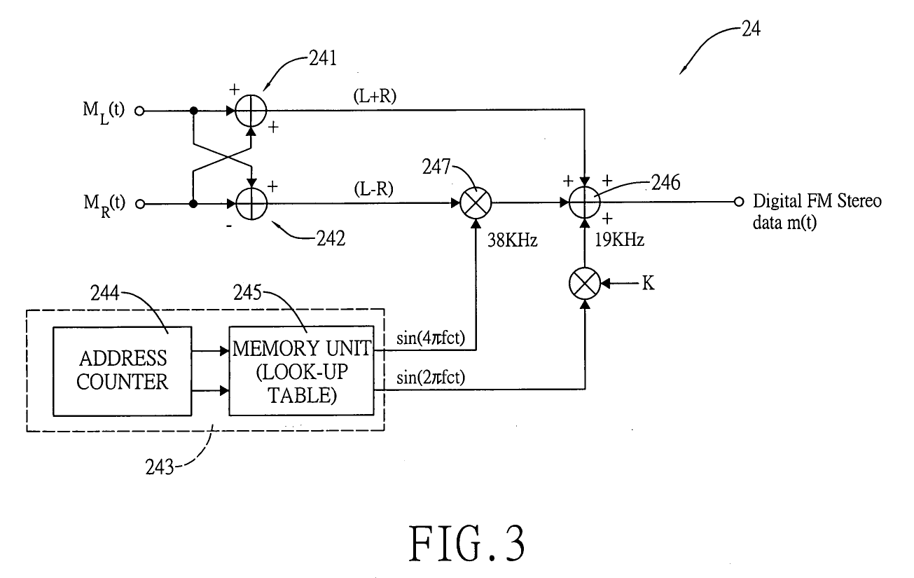

With reference to FIG. 3, a detailed circuit block diagram of the FM stereo multiplexer 24 in accordance with the present invention has a fist adder 241, a substracter 242, a switch-and-pilot-signal generator unit 243 having an address counter 244 and a memory unit 245, a second adder 246 and a synthesizer 247.

The first adder 241 is coupled to the two over-sampling units 23 to acquire the sampled left and right channel audio signals (L/R), so as to generate a master signal L+R.

The substracter 242 is coupled to the two over-sampling units 23 to acquire the sampled left and right channel audio signals (L/R), so as to generate a secondary signal L−R.

The switch-and-pilot-signal generator unit 243 is made up by the address counter 244 and the memory unit 245. The memory unit 245 stores multiple different frequency sine-wave signal samples and quantified values. In accordance with phase variation of the sine-wave signal, continuous addresses store the sine-wave signal of different corresponding voltage values in different phases. To co-operate with the address counter 244 to circulate counting, the memory unit 245 continuously outputs the sine-wave signals of the current required pilot signal the switch signal, which is a so-called look-up table method. In this preferred embodiment, the switch signal and the sine-wave signal of the pilot signal are respectively represented as sin(4πf_{c}t) and sin(2πf_{c}t), wherein the f_{c}=19 KHz. Hence the switch signal is 38 KHz and the pilot signal is 19 KHz. The switch signal is combined with the secondary signal by the synthesizer 247 to a combination signal output to the second adder 246. Then the second adder 246 adds the combination signal, the master signal and the pilot signal to output the digital FM stereo data m(t).

It can be understood from the above configuration of the digitized FM stereo multiplexing circuit 20 that when the digital audio data is inputted, the digital audio decoder 21 decodes the digital audio data to acquire the left channel audio signal and the right channel audio signal. The left channel audio signal and the right channel audio signal are inputted to the over-sampling unit circuits 23 to process sampling and then to output to the FM stereo multiplexer 24. The FM stereo multiplexer 24 then generates the master signal and the secondary signal by processing the sampled left channel audio signal and the right channel audio signal. In the meanwhile the switch signal and the pilot signal are acquired with the address counter 244 to output from the memory unit 245. Then the master signal, the secondary signal and the pilot signal are combined as the digital FM stereo data.

Then the digital FM stereo data is synchronized to be matching and the noise is adjusted to make the digital FM stereo data outputted to the low-pass filter with a serial of one bit data stream. Since the noise of the digital FM stereo data is adjusted to the high frequency area, the noise can be filtered by going through the low-pass filter. Hence the high quality analogy stereo signal can be restored.

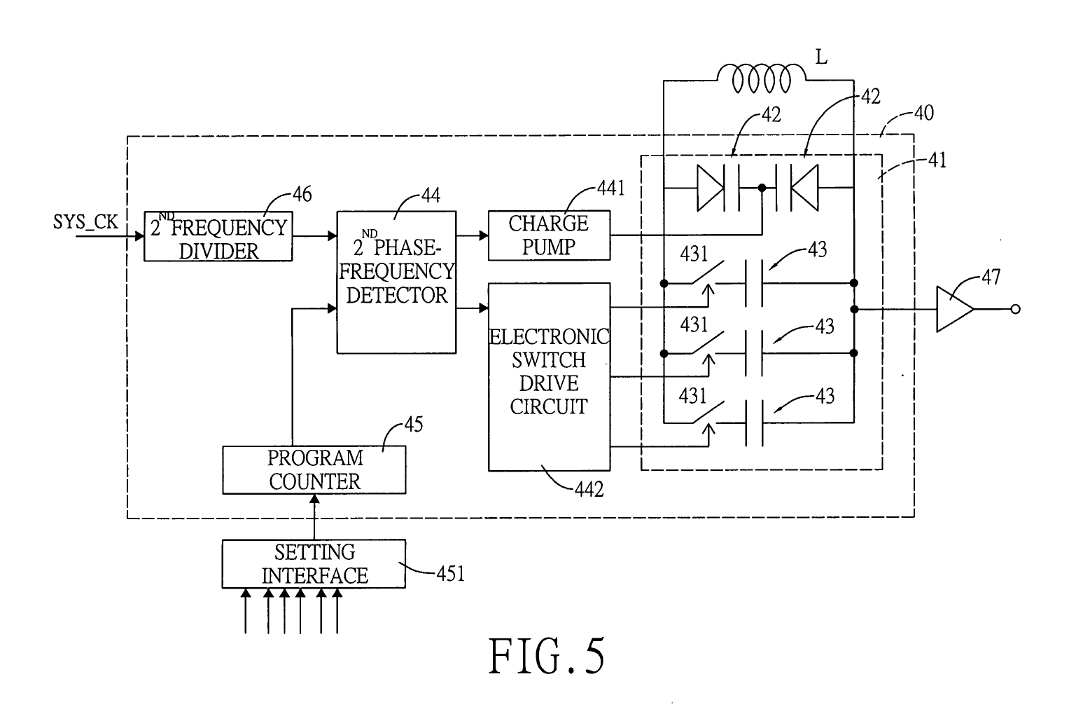

With reference to FIG. 5, a circuit block diagram of the FM circuit 40 in accordance with the present invention has a resonance circuit 41, a second phase-frequency detector 44, a program counter 45, a second frequency divider and an RF amplifier 47.

The resonance circuit 41 has two variable capacitance diodes 42, multiple capacitors 43 and an inductance L. The capacitors 43 are respectively parallel-connected to the variable capacitance diodes 42 and the inductance L. Every capacitor 43 is serial-connected with an electronic switch 431.

The second phase-frequency detector 44 has a first output terminal coupled to control terminals of the electronic switches 431 of the resonance circuit 41 via an electronic switch drive circuit 442 and a second output terminal coupled to a connection node of the two variable capacitance diodes 42 via a charge pump In this way, the resonance circuit 41 can be controlled by two signals to control a resonance frequency. That is to say, the capacitors 43 form a digitized frequency rough-tune function and the two variable capacitance diodes 42 provide analogy fine-tune function, which is different from the conventional resonance circuit.

The program counter 45 has an input terminal via a setting interface 451 to provide for users to set a counter value. An output terminal of the program counter 45 is coupled to a first input terminal of the second phase-frequency detector 44.

The second frequency divider 46 has an input terminal coupled to the system clock signal SYS_CK, so as to divide the frequency of the system clock signal SYS_CK to output to a second input terminal of the second phase-frequency detector 44.

The RF amplifier 47 has an input terminal coupled to an output terminal of the resonance circuit 41 for coupling to the RF antenna 50.

The aforesaid FM circuit 40 uses the program counter 45 to output an FM signal corresponding to the user's setting to the second phase-frequency detector 44. At this moment, the second phase-frequency detector 44 compares the FM signal with the frequency divided system clock counter SYS_CK. The electronic switch drive circuit 442 and the charge pump 441 process rough-tune and fine-tune in accordance with a contrast result of the second phase-frequency detector to adjust the resonance frequency of the resonance circuit 41. Eventually the RF amplifier 47 sends out the modulated stereo audio signal to the RF antenna 50.

To sum up, the present invention is to provide a digitized frequency modulation stereo multiplexing circuit to directly process the digitized audio data.

Since the digitized frequency modulation stereo multiplexing circuit uses a digitized circuit design, the present invention is superior to the conventional analogy circuit to achieve a good anti-noise objective. Moreover, the digital output can get rid of the conventional D/A converter and only needs to use the low-pass filter to convert into the analogy signal, which is very simple. Further, the conventional 8-40 MHz system clock signal can be direct used without using the quartz crystal oscillator for multiplexing modulation. The resonance circuit also uses digital and analogy rough-tune and fine-tune functions, which is much more precise than the conventional resonance circuit. Therefore the present invention is indeed a novel and improved design.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A digitized FM (frequency modulation) stereo transmitter comprising:
a digital audio I/O interface adapted to couple with a compatible digital audio storage device to acquire digital audio data from the compatible digital audio storage device;
a digitized FM stereo multiplexing circuit acquiring parallel digital audio data via the digital audio I/O interface to process digitized multiplexing modulation, and then to output a stereo composition signal of serial digital data format is outputted;
a low-pass filter coupled to the digitized FM stereo multiplexing circuit to transform the stereo composition signal of the serial digital data format into an analogy stereo composition signal to output; and
an FM circuit coupled to the low-pass filter and a radio frequency (RF) antenna for loading the analogy stereo composition signal to a radio frequency carrier to generate an FM stereo signal, and then the RF antenna radiating out the FM stereo signal.

2. The digitized FM stereo transmitter as claimed in claim 1, wherein the digitized FM stereo multiplexing circuit comprising:
a digital audio decoder coupled to the digital audio I/O interface to acquire the parallel digital audio data to decode the parallel digital audio data and respectively output a left channel audio signal and a right channel audio signal;
two pre-emphasis circuits respectively coupled to output terminals of the digital audio decoder, wherein the two pre-emphasis circuits enhance a signal-to-noise ratio of a high frequency area of the corresponding left channel audio signal and right channel audio signal, so as to avoid noise interference of high frequency environment;
two over-sampling unit circuits coupled to the two pre-emphasis circuits to process sampling on the left channel audio signal and the right channel audio signal;
an FM stereo multiplexer coupled to output terminals of the two over-sampling unit circuits to combine the sampled left channel audio signal and the right channel audio signal with a pilot signal, so as to output a digital FM stereo data;
a re-sampling circuit coupled to an output terminal of the FM stereo multiplexer and a reference signal to make the digital FM stereo data synchronized to be matching with the reference signal; and
a noise shaper coupled to an output terminal of the re-sampling circuit to acquire the digital FM stereo data, so as to lift a noise of a digital stereo audio signal to the high frequency area, and then to output to the low-pass filter, so as to filter the noise of the high frequency area and to convert into an analogy signal.

3. The digitized FM stereo transmitter as claimed in claim 2, wherein the re-sampling circuit comprises a first phase-frequency detector, an accumulator, a first frequency divider and a D-Type Flip-Flop; wherein the first phase-frequency detector is coupled to a reference clock signal to check with a system clock signal, wherein the system clock signal is inputted to the accumulator and then further processed by the first frequency divider to be simultaneously outputted to the first phase-frequency detector with the reference clock signal, at this moment, the first phase-frequency detector detects a phase contrast of the two clock signals and then inputs to the accumulator, and eventually a reference signal divided by N is outputted to a clock terminal of the D-Type Flip-Flop; wherein at this moment, an input terminal of the D-Type Flip-Flop is coupled to an output terminal of the FM stereo multiplexer.

4. The digitized FM stereo transmitter as claimed in claim 3, wherein the system clock signal chooses one frequency signal from 8-40 MHz.

5. The digitized FM stereo transmitter as claimed in claim 2, wherein the FM stereo multiplexer comprises:
a first adder coupled to the two over-sampling units to acquire the sampled left and the right channel audio signals, so as to generate a master signal;
a substracter coupled to the two over-sampling units to acquire the sampled left and right channel audio signals, so as to generate a secondary signal; and
a switch-and-pilot-signal generator unit made up by an address counter and a memory unit; wherein the memory unit stores multiple different frequency sine-wave signal samples and quantified values; wherein in accordance with phase variation of the sine-wave signal, continuous addresses store the sine-wave signal of different corresponding voltage values in different phases; wherein with the address counter the memory unit continuously outputs the sine-wave signals of the pilot signal and the switch signal, wherein the switch signal is combined with the secondary signal to output to a second adder, wherein the second adder and the synthesizer add a combination signal, a secondary signal and a pilot signal to output a digital FM stereo data.

6. The digitized FM stereo transmitter as claimed in claim 3, wherein the FM stereo multiplexer comprises:
a first adder coupled to the two over-sampling units to acquire the sampled left and the right channel audio signals, so as to generate a master signal;
a substracter coupled to the two over-sampling units to acquire the sampled left and right channel audio signals, so as to generate a secondary signal; and
a switch-and-pilot-signal generator unit made up by an address counter and a memory unit; wherein the memory unit stores multiple different frequency sine-wave signal samples and quantified values; wherein in accordance with phase variation of the sine-wave signal, continuous addresses store the sine-wave signal of different corresponding voltage values in different phases; wherein with the address counter the memory unit continuously outputs the sine-wave signals of the pilot signal and the switch signal, wherein the switch signal is combined with the secondary signal to output to a second adder, wherein the second adder and the synthesizer add a combination signal, a secondary signal and a pilot signal to output a digital FM stereo data.

7. The digitized FM stereo transmitter as claimed in claim 4, wherein the FM stereo multiplexer comprises:
a first adder coupled to the two over-sampling units to acquire the sampled left and the right channel audio signals, so as to generate a master signal;
a substracter coupled to the two over-sampling units to acquire the sampled left and right channel audio signals, so as to generate a secondary signal; and
a switch-and-pilot-signal generator unit made up by an address counter and a memory unit; wherein the memory unit stores multiple different frequency sine-wave signal samples and quantified values; wherein in accordance with phase variation of the sine-wave signal, continuous addresses store the sine-wave signal of different corresponding voltage values in different phases; wherein with the address counter the memory unit continuously outputs the sine-wave signals of the pilot signal and the switch signal, wherein the switch signal is combined with the secondary signal to output to a second adder, wherein the second adder and the synthesizer add a combination signal, a secondary signal and a pilot signal to output a digital FM stereo data.

8. The digitized FM stereo transmitter as claimed in claim 2, wherein the FM circuit comprises:
a resonance circuit having two variable capacitance diodes, a plurality of capacitors and an inductance; wherein the capacitors are respectively parallel-connected to the two variable capacitance diodes and the inductance, wherein every capacitor is serial-connected with an electronic switch;
a second phase-frequency detector having a first output terminal coupled to control terminals of the electronic switches of the resonance circuit via an electronic switch drive circuit and a second output terminal coupled to the variable capacitance diodes via a charge pump;
a program counter having an input terminal via a setting interface to provide for users to set a counter value and an output terminal coupled to a first input terminal of the second phase-frequency detector;
a second frequency divider having an input terminal coupled to the system clock signal, so as to divide the frequency of the system clock signal to output to a second input terminal of the second phase-frequency detector; and
an amplifier having an input terminal coupled to an output terminal of the resonance circuit for coupling to the antenna.

9. The digitized FM stereo transmitter as claimed in claim 3, wherein the FM circuit comprises:
a resonance circuit having two variable capacitance diodes, a plurality of capacitors and an inductance; wherein the capacitors are respectively parallel-connected to the two variable capacitance diodes and the inductance, wherein every capacitor is serial-connected with an electronic switch;
a second phase-frequency detector having a first output terminal coupled to control terminals of the electronic switches of the resonance circuit via an electronic switch drive circuit and a second output terminal coupled to the variable capacitance diodes via a charge pump;
a program counter having an input terminal via a setting interface to provide for users to set a counter value and an output terminal coupled to a first input terminal of the second phase-frequency detector;
a second frequency divider having an input terminal coupled to the system clock signal, so as to divide the frequency of the system clock signal to output to a second input terminal of the second phase-frequency detector; and
an amplifier having an input terminal coupled to an output terminal of the resonance circuit for coupling to the antenna.

10. The digitized FM stereo transmitter as claimed in claim 4, wherein the FM circuit comprises:
a resonance circuit having two variable capacitance diodes, a plurality of capacitors and an inductance; wherein the capacitors are respectively parallel-connected to the two variable capacitance diodes and the inductance, wherein every capacitor is serial-connected with an electronic switch;
a second phase-frequency detector having a first output terminal coupled to control terminals of the electronic switches of the resonance circuit via an electronic switch drive circuit and a second output terminal coupled to the variable capacitance diodes via a charge pump;
a program counter having an input terminal via a setting interface to provide for users to set a counter value and an output terminal coupled to a first input terminal of the second phase-frequency detector;
a second frequency divider having an input terminal coupled to the system clock signal, so as to divide the frequency of the system clock signal to output to a second input terminal of the second phase-frequency detector; and
an amplifier having an input terminal coupled to an output terminal of the resonance circuit for coupling to the antenna.

11. The digitized FM stereo transmitter as claimed in claim 2, wherein the noise shaper is a sigma-delta modulator.

12. The digitized FM stereo transmitter as claimed in claim 1, wherein the digital audio I/O interface is of IIS or IIC digital audio format interface.

13. A digitized FM stereo multiplexing circuit for an FM stereo transmitter comprising:
a digital audio decoder coupled to the digital audio I/O interface to acquire the parallel digital audio data to decode the parallel digital audio data and respectively output a left channel audio signal and a right channel audio signal;
two pre-emphasis circuits respectively coupled to output terminals of the digital audio decoder, wherein the two pre-emphasis circuits enhance a signal-to-noise ratio of a high frequency area of the corresponding left channel audio signal and right channel audio signal, so as to avoid noise interference of high frequency environment;
two over-sampling unit circuits coupled to the two pre-emphasis circuits to process sampling on the left channel audio signal and the right channel audio signal;
an FM stereo multiplexer coupled to output terminals of the two over-sampling unit circuits to combine the sampled left channel audio signal and the right channel audio signal with a pilot signal, so as to output a digital FM stereo data;
a re-sampling circuit coupled to an output terminal of the FM stereo multiplexer and a reference signal to make the digital FM stereo data synchronized to be matching with the reference signal; and
a noise shaper coupled to an output terminal of the re-sampling circuit to acquire the digital FM stereo data, so as to lift a noise of a digital stereo audio signal to the high frequency area, and then to output to the low-pass filter, so as to filter the noise of the high frequency area and to convert into an analogy signal.

14. The digitized FM stereo multiplexing circuit as claimed in claim 13, wherein the re-sampling circuit comprises a first phase-frequency detector, an accumulator, a first frequency divider and a D-Type Flip-Flop; wherein the first phase-frequency detector is coupled to a reference clock signal to check with a system clock signal, wherein the system clock signal is inputted to the accumulator and then further processed by the first frequency divider to be simultaneously outputted to the first phase-frequency detector with the reference clock signal, at this moment, the first phase-frequency detector detects a phase contrast of the two clock signals and then inputs to the accumulator, and eventually a reference signal divided by N is outputted to a clock terminal of the D-Type Flip-Flop; wherein at this moment, an input terminal of the D-Type Flip-Flop is coupled to an output terminal of the FM stereo multiplexer.

15. The digitized FM stereo multiplexing circuit as claimed in claim 14, wherein the system clock signal chooses one frequency signal from 8-40 MHz.

16. The digitized FM stereo multiplexing circuit as claimed in claim 13, wherein the FM stereo multiplexer comprises:
a fist adder coupled to the two over-sampling units to acquire the sampled left and the right channel audio signals, so as to generate a master signal;
a substracter coupled to the two over-sampling units to acquire the sampled left and right channel audio signals, so as to generate a secondary signal; and
a switch-and-pilot-signal generator unit made up by an address counter and a memory unit; wherein the memory unit stores multiple different frequency sine-wave signal samples and quantified values; wherein in accordance with phase variation of the sine-wave signal, continuous addresses store the sine-wave signal of different corresponding voltage values in different phases; wherein with the address counter the memory unit continuously outputs the sine-wave signals of the pilot signal and the switch signal, wherein the switch signal is combined with the secondary signal to output to a second adder, wherein the second adder and the synthesizer add a combination signal, a secondary signal and a pilot signal to output a digital FM stereo data.

17. The digitized FM stereo multiplexing circuit as claimed in claim 14, wherein the FM stereo multiplexer comprises:
a first adder coupled to the two over-sampling units to acquire the sampled left and the right channel audio signals, so as to generate a master signal;
a substracter coupled to the two over-sampling units to acquire the sampled left and right channel audio signals, so as to generate a secondary signal; and
a switch-and-pilot-signal generator unit made up by an address counter and a memory unit; wherein the memory unit stores multiple different frequency sine-wave signal samples and quantified values; wherein in accordance with phase variation of the sine-wave signal, continuous addresses store the sine-wave signal of different corresponding voltage values in different phases; wherein with the address counter the memory unit continuously outputs the sine-wave signals of the pilot signal and the switch signal, wherein the switch signal is combined with the secondary signal to output to a second adder, wherein the second adder and the synthesizer add a combination signal, a secondary signal and a pilot signal to output a digital FM stereo data.

18. The digitized FM stereo multiplexing circuit as claimed in claim 15, wherein the FM stereo multiplexer comprises:
a first adder coupled to the two over-sampling units to acquire the sampled left and the right channel audio signals, so as to generate a master signal;
a substracter coupled to the two over-sampling units to acquire the sampled left and right channel audio signals, so as to generate a secondary signal; and
a switch-and-pilot-signal generator unit made up by an address counter and a memory unit; wherein the memory unit stores multiple different frequency sine-wave signal samples and quantified values; wherein in accordance with phase variation of the sine-wave signal, continuous addresses store the sine-wave signal of different corresponding voltage values in different phases; wherein with the address counter the memory unit continuously outputs the sine-wave signals of the pilot signal and the switch signal, wherein the switch signal is combined with the secondary signal to output to a second adder, wherein the second adder and the synthesizer add a combination signal, a secondary signal and a pilot signal to output a digital FM stereo data.

19. The digitized FM stereo multiplexing circuit as claimed in claim 13, wherein the noise shaper is a sigma-delta modulator.
